(19) United States
(12) Patent Application Publication
(10) Pub. No.: US 2010/0250583 A1
(43) Pub. Date: Sep. 30, 2010

(54) Social Network Query and Response System to Locate Subject Matter Expertise

(75) Inventor: Reinhard Peter Klemm, Basking Ridge, NJ (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/640,312

(22) Filed: Dec. 17, 2009

Related U.S. Application Data
(60) Provisional application No. 61/163,221, filed on Mar. 25, 2009.

(51) Int. Cl. G06F 17/30; G06F 15/16

(52) U.S. Cl. 707/769; 709/204; 707/E17.014

(57) ABSTRACT

A method for identifying a person who possesses the expertise in a specific subject matter, wherein the method comprises receiving a query and criteria from a first user and, transmitting a request to a server. Upon receiving the request, the server selects a second user from the first user's contacts based on the request. Similarly, the server selects a third user from the second user's contacts, wherein the third user is not in the first user's contacts. After the users are selected, the server transmits the request to the second user and the third user's terminal. If the second user and the third user do not respond to the request, the server selects a fourth user from the third user's contacts, wherein the fourth user is not in the first user and the second user's contacts. This process is performed by the server until an “expert” responds to the request.

### FIELD OF THE INVENTION

The present invention relates to telecommunications in general, and, more particularly, to a query and response system.

### BACKGROUND OF THE INVENTION

Trying to discover or locate a person who has extensive knowledge and years of experience in a specific subject matter can be difficult, especially in a large enterprise.

This difficult task of discovering and locating an “expert” in a specific subject matter becomes more difficult as the size of the enterprise increases or, when the expertise sought to be discovered becomes more specific.

In an attempt to solve the task of discovering and locating an “expert,” people mentally develop social networks based on, for example:
i. past interactions with other people who have helped them solve a specific problem,
ii. past interactions with other people who have helped them locate a person with similar expertise, or
iii. the passing of information from person to person (i.e., “word-of-mouth”).

This first attempt to solve the task of discovering and locating an “expert” is inefficient because a person may not remember who helped them solve past problems or, who in the past helped them locate a person with similar expertise or, whether the information passed from person to person is reliable.

In another attempt, prior art systems used complex algorithms to solve the task of discovering and locating an “expert.” Because these complex algorithms have not fully evolved, they often fell short of the desired result of quickly discovering and locating an “expert.”

Moreover, these complex algorithms required specialized data-processing systems to execute their method of discovering and locating an “expert.” By implementing these specialized prior art data-processing systems with the existing infrastructure of enterprises, the overhead expenses of an enterprise is increased.

Therefore, there exists a need for a method and system that can efficiently and accurately discover and locate specific subject matter expertise without some of the cost and disadvantageous associated with the systems of the prior art.

### SUMMARY OF THE INVENTION

The present invention provides a method of discovering and locating a person who possesses the expertise in a specific subject matter in a way that avoids some of the costs and disadvantageous of prior art methods and systems.

The present invention exploits the use of social communities and a user's social network (i.e., a user's list of contacts) to discover and locate a person who possesses the expertise in a specific subject matter.

In one embodiment of the present invention, discovering and locating a person who possesses the expertise in a specific subject matter is performed by a server. When a first user U₁ at a telecommunications terminal inputs a query with one or more criteria via an interface, a request is transmitted from the first user U₁'s telecommunications terminal to a server.

Once the server receives the first user U₁'s request to identify a person who possesses the expertise in a specific subject matter, the server selects a second user U₂ from the first user U₁'s contacts based, at least in part, on whether:
i. the first user U₁'s request satisfies the second user U₂'s profile,
ii. the first user U₁'s one or more criteria satisfies the second user U₂'s profile, or
iii. a combination of i and ii.

In the same or similar fashion, the server selects a third user U₃ from the second user U₂'s contacts, wherein the third user U₃ is not in the first user U₁'s contacts—in other words, the second user U₂ is not in the first user U₁'s contacts because the first user U₁ is not aware of the third user U₃'s presence and expertise.

Once the second user U₂ and the third user U₃ are selected, the server transmits the first user U₁'s request to the second user U₂'s telecommunications terminal and the third user U₃'s telecommunications terminal.

If a response to the first user U₁'s request is received from the second user U₂'s telecommunications terminal and/or the third user U₃'s telecommunications terminal, the server transmits the response to the first user U₁'s telecommunications terminal.

On the other hand, if no response is received from the second user U₂'s telecommunications terminal and the third user U₃'s telecommunications terminal or, if the response indicates that the second user U₂ and the third user U₃ are both unavailable to respond to the first user U₁'s request, the server selects a fourth user U₄ from the third user U₃'s contacts, wherein the fourth user U₄ is not in the first user U₁ and the second user U₂'s contacts. This process of selecting a user is performed by the server until an “expert” responds to the first user U₁'s request.

In accordance with another embodiment of the present invention, discovering and locating a person who possesses the expertise in a specific subject matter is performed by an application executed on a user's telecommunications terminal.

When a first user U₁ at a telecommunications terminal inputs a query with one or more criteria via an interface, an application executed on the first user U₁'s telecommunications terminal selects a second user U₂ from the first user U₁'s contacts and transmits a request to the second user U₂'s telecommunications terminal.

Once the second user U₂'s telecommunications terminal receives the first user U₁'s request, an application executed on the second user U₂'s telecommunications terminal analyzes the first user U₁'s request and presents the request to the second user U₂ when, and only when:
i. the first user U₁'s request satisfies the second user U₂'s profile,
ii. the first user U₁'s one or more criteria satisfies the second user U₂'s profile, or
iii. a combination of i and ii.

If the application executed on the second user U₂'s telecommunications determines that the first user U₁'s request and the one or more criteria satisfies the second user U₂'s profile, the application presents the first user U₁'s request to the second user U₂.

On the other hand, if the application executed on the second user U₂'s telecommunications terminal determines that the first user U₁'s request and/or the one or more criteria does not satisfy the second user U₂'s profile, the application selects:
i. a third user U₃ from the second user U₂'s contacts,
ii. a fourth user U₄ from the second user U₂'s contacts, and
iii. presents the third user U₃ and the fourth user U₄ to the second user U₂ for selection.

Upon receiving a selection from the second user U₂, the application executed on the second user U₂'s telecommunications transmits the first user U₁'s request based, at least in part, on the second user U₂'s selection. This process of selecting a user is performed by an application executed on each user's telecommunications terminal until an “expert” responds to the first user U₁'s request.

The illustrative embodiment of the present invention comprises: (i) receiving, at a data-processing system, a request from a first user U₁, (ii) selecting, at the data-processing system a second user U₂ from a plurality of contacts of the first user U₁, wherein the request satisfies the second user U₂'s profile, and a third user U₃ from a plurality of contacts of the second user U₂, wherein the request satisfies the third user U₃'s profile, and wherein the third user U₃ is not in the plurality of contacts of the first user U₁, (iii) transmitting the request from the data-processing system to the third user U₃, (iv) receiving, at the data-processing system, a response to the request from the third user U₃, and (v) transmitting, at the data-processing system, the response to the first user U₁.

### BRIEF DESCRIPTION OF THE DRAWINGS

FIG. 1 depicts a schematic diagram of the salient components of telecommunications systems 100 in accordance with the illustrative embodiment of the present invention.

FIG. 2 depicts the salient components of server 102.

FIG. 3 depicts the salient components of a user Uᵢ's telecommunications terminal 101-i.

FIG. 4 depicts a flowchart of the salient tasks associated with the operation of the first illustrative embodiment of the present invention.

FIG. 5 depicts a flowchart of the salient task associated with the operation of task 402 in accordance with the first illustrative embodiment of the present invention.

FIG. 6 depicts a flowchart of the salient task associated with the operation of task 403 in accordance with the first illustrative embodiment of the present invention.

FIG. 7 depicts a flowchart of the salient tasks associated with the operation of the second illustrative embodiment of the present invention.

FIG. 8 depicts a flowchart of the salient tasks associated with the operation of the second illustrative embodiment of the present invention.

FIG. 9 depicts a flowchart of the salient task associated with the operation of task 803 in accordance with the second illustrative embodiment of the present invention.

FIG. 10 depicts a flowchart of the salient task associated with the operation of task 804 in accordance with the second illustrative embodiment of the present invention.

FIG. 11 depicts a flowchart of the salient task associated with the operation of task 805 in accordance with the second illustrative embodiment of the present invention.

### DETAILED DESCRIPTION

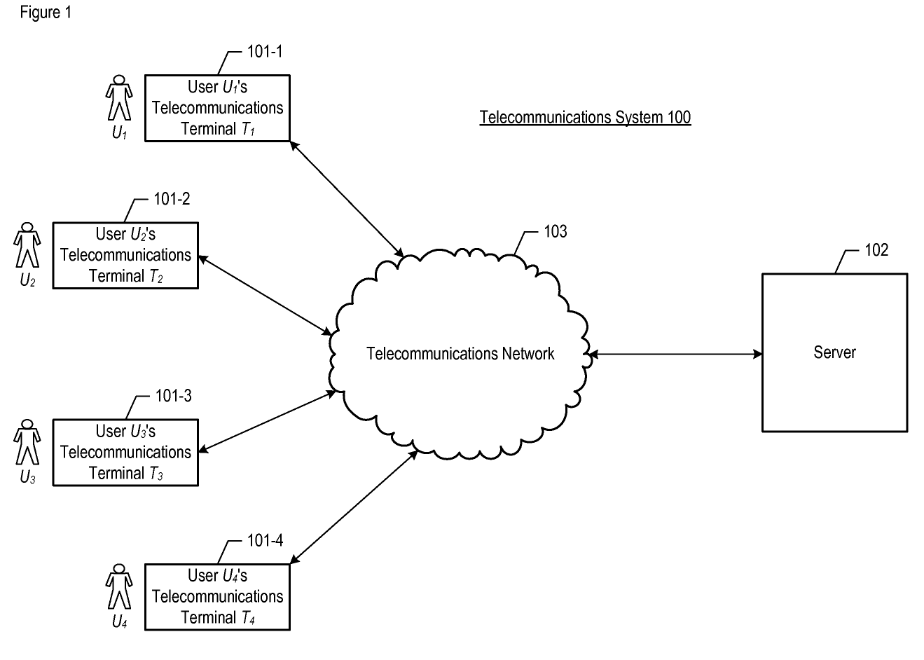

FIG. 1 depicts a schematic diagram of the salient components of telecommunications system 100 in accordance with the illustrative embodiment of the present invention. Telecommunications system 100 comprises: user telecommunications terminals 101-1 through 101-4, server 102, and telecommunications network 103, interconnected as shown.

Although the illustrative embodiment comprises four user telecommunications terminals 101-1 through 101-4, it will be clear to those skilled in the art, after reading this disclosure, how to make and use alternative embodiments of the present invention that comprises any number of user telecommunications terminals (e.g., five user telecommunications terminals, six user telecommunications terminals, seven user telecommunications terminals, etc.).

Although the illustrative embodiment comprises one server 102, it will be clear to those skilled in the art, after reading this disclosure, how to make and use alternative embodiments of the present invention that comprises any number or any combination of servers.

Although the illustrative embodiment comprises one telecommunications network 103, it will be clear to those skilled in the art, after reading this disclosure, how to make and use alternative embodiments of the present invention that comprises any number and combination of telecommunications networks.

User Uᵢ wherein iε{1, 2, 3, 4}, is a person at telecommunications terminal 101-i who desires to obtain information on a specific subject matter. Telecommunications terminal 101-i comprises the hardware and software to enable a user Uᵢ to, for example, and without limitation, contact and interact with:

i. telecommunications terminal 101-1,

ii. telecommunications terminal 101-2,

iii. telecommunications terminal 101-3,

iv. telecommunications terminal 101-4, and

v. server 102

through telecommunications network 103. Additionally, telecommunications terminal 101-i comprises the hardware and software to, for example, and without limitation:
i. present an interface to a user so that the user can input a query and/or one or more criteria of the query,
ii. transmit a request (i.e., a user's query and/or one or more criteria of the query) to other telecommunications terminals 101-i and/or server 102 via telecommunications network 103, wherein the request is to identify a person who possesses the expertise that can respond to the user's query,
iii. receive a request from other telecommunications terminals 101-i and/or server 102 via telecommunications network 103,
iv. select a user from a list of contacts,
v. present a request to a user when, and only when, the request satisfies the user's profile,
vi. set a flag to prevent a user from receiving the same request (i.e., prevent looping of a request),
vii. forward a response to all telecommunications terminal 101-i that received the request so that other users can learn from the response,
viii. monitor the number of times a user established a communications session with another user,
ix. monitor the duration of time a user communicated with another user,
x. monitor the date and time a user communicated with another user,
xi. monitor the number of times a user was selected to respond to a request,
xii. determine the subject matter of a conference call that the user participated in,
xiii. determine the subject matter of a document submitted by the user, or
xiv. any combination of i, ii, iii, iv, v, vi, vii, viii, ix, x, xi, xii, and viii.

In accordance with the illustrative embodiment, telecommunications terminal 101-i are wireline telecommunications terminals (e.g., an office deskset, a desktop, a computer, etc.) but it will be clear to those skilled in the art, after reading this disclosure, how to make and use alternative embodiments of the present invention in which some or all of telecommunications terminals 101-i connect to telecommunications network 103 via wireless (e.g., a cell phone, a personal digital assistant, a smart-phone, etc.).

Additionally, it will be clear to those skilled in the art, after reading this disclosure, how to make and use alternative embodiments of the present invention in which telecommunications terminal 101-i enables a user Uᵢ to contact other telecommunications terminals and server 102 via a different modality, for example, and without limitation, web requests, e-mail, instant messaging, short-message services, video, voice, etc. In any case, telecommunications terminal 101-i is capable of performing the tasks described below and in the accompanying figures.

Server 102 comprises the hardware and software to, for example, and without limitation:
i. receive a request (i.e., a user's query and/or one or more criteria of the query) from a user at a telecommunications terminal 101-i via telecommunications network 103, wherein the request is to identify a person who possesses the expertise that can respond to the user's query,
ii. select a user from a list of contacts based, at least in part, on the request satisfying the user's profile,
iii. select a user from a list of contacts based, at least in part, on the one or more criteria of the request satisfying the user's profile,
iv. transmit a request to other telecommunications terminals 101-i via telecommunications network 103,
v. set a flag to prevent a user from receiving the same request (i.e., prevent looping of a request),
vi. forward a response to all telecommunications terminal 101-i that received the request so that other users can learn from the response,
vii. monitor the number of times a user established a communications session with another user,
viii. monitor the duration of time a user communicated with another user,
ix. monitor the date and time a user communicated with another user,
x. monitor the number of times a user was selected to respond to a request,
xi. determine the subject matter of a conference call that the user participated in,
xii. determine the subject matter of a document submitted by the user, or
xiii. any combination of i, ii, iii, iv, v, vi, vii, viii, ix, x, xi, and xii.

It will be clear to those skilled in the art, after reading this disclosure, how to make and use alternative embodiments of the present invention in which server 102 is a Private Branch Exchange (PBX), a gateway, a proxy server, a Web server, etc. In any case, server 102 is capable of performing the tasks described below and in the accompanying figures.

Telecommunications network 103 is the Internet, but it will be clear to those skilled in the art, after reading this disclosure, how to make and use alternative embodiments of the present invention in which telecommunications network 103 is a different network or a combination of different networks, for example, and without limitation, the Public Switched Telephone Network (PSTN), a satellite network, a private data network such as an enterprise's intranet, etc.

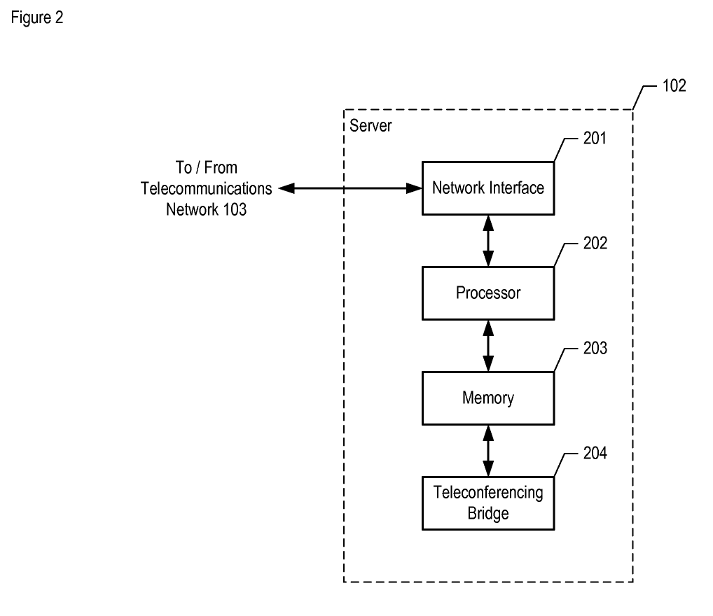

FIG. 2 depicts the salient components of server 102. Server 102 comprises network interface 201, processor 202, memory 203, and teleconferencing bridge 204 interconnected as shown. It will be clear to those skilled in the art, after reading this disclosure, how to make and use alternative embodiments of the present invention in which server 102 comprises any subcombination of the components listed above.

Network interface 201 comprises the circuitry that enables server 102 to receive signals from and, transmit signals to, telecommunications terminal 101-i, a database, a gateway, other servers such as a proxy server, a Web server, etc.

Processor 202 is a general-purpose processor that is capable of receiving information from and transmitting information to network interface 201, executing the instructions stored in memory 203, including the instructions that correspond to the tasks of the illustrative embodiment, and reading data from and writing data into memory 203. In some alternative embodiments of the present invention, processor 202 is a special-purpose processor.

Memory 203 stores the instructions and data used by processor 202, in well-known fashion. Memory 203 also stores, for example, and without limitation, a profile associated with a user Uᵢ. The profile comprises, for example, and without limitation:
i. the user Uᵢ's first name and last name,
ii. the user Uᵢ's geographic location,
iii. the academic institution that the user Uᵢ graduated from,
iv. the field of study that the user Uᵢ majored in while attending the academic institution,
v. the enterprise (i.e., employer) that the user Uᵢ is currently working for,
vi. the department that the user Uᵢ is currently assigned to in the enterprise,
vii. a description of the user Uᵢ's daily task as a member of this department,
viii. the social groups that the user Uᵢ is a member of,
ix. the documents that the user Uᵢ has worked on or published in the past,
x. the user Uᵢ's expertise,
xi. the user Uᵢ's interests,
xii. the user Uᵢ's contact information,
xiii. a unique identifier of the user Uᵢ at telecommunications terminal 101-i,
xiv. the user Uᵢ's contacts—in other words, a unique identifier of other users in the user Uᵢ's social network (e.g., a unique identifier of a first user U₁ at telecommunications terminal 101-1, a second user U₂ at telecommunications terminal 101-2, a third user U₃ at telecommunications terminal 101-3, etc.),
xv. the number of times the telecommunications terminal 101-i transmitted a request to another telecommunications terminal,
xvi. a list of users that the telecommunications terminal 101-i transmitted a request to,
xvii. the number of times the user Uᵢ at telecommunications terminal 101-i established a communications session with another user,
xviii. the duration of time the user Uᵢ at telecommunications terminal 101-i communicated with another user,
xix. the date and time the user Uᵢ at telecommunications terminal 101-i communicated with another user,
xx. the number of times the user Uᵢ at telecommunications terminal 101-i was selected by the server 102 to respond to another user's request,
xxi. the subject matter of a conference call that the user Uᵢ at telecommunications terminal 101-i participated in,
xxii. the subject matter of a document submitted by the user Uᵢ at telecommunications terminal 101-i,
xxiii. the number of times the user Uᵢ at telecommunications terminal 101-i received a request from other telecommunications terminals,
xxiv. the number of times the user Uᵢ at telecommunications 101-i responded to another user's request, or
xxv. any combination of i, ii, iii, iv, v, vi, vii, viii, ix, x, xi, xii, xiii, xiv, xv, xvi, xvii, xviii, xix, xx, xxi, xxii, xxiii, and xxiv.

It will be clear to those skilled in the art, after reading this disclosure, how to make and use alternative embodiments of the present invention in which some of the user Uᵢ's information and data listed above are stored in one or more profiles associated with the user Uᵢ.

Additionally, it will be clear to those skilled in the art, after reading this disclosure, how to make and use alternative embodiments of the present invention in which memory 203 can be any combination of dynamic random-access memory (RAM), flash memory, disk drive memory, and so forth.

Furthermore, it will be clear to those skilled in the art, after reading this disclosure, how to make and use alternative embodiments of the present invention in which some or all of the instructions and data used by processor 202 are stored in a different memory or database that is part of or, separate from, server 102.

Teleconferencing bridge 204 comprises the hardware and software to enable a user Uᵢ at telecommunications terminals 101-i to connect and communicate with other telecommunications terminals. At designated times, server 102 is configured to set up one or more teleconferencing bridges to allow multiple telecommunications terminals to connect with one another.

Additionally, server 102 is configured to schedule more than one conference call on the same teleconferencing bridge at the same time. These teleconferencing bridges can host conference calls with as few as two people, with no pre-set upper limit on the number of telecommunications terminals in a conference call.

Furthermore, these teleconferencing bridges can be part of or, separate from, server 102. It will be clear to those skilled in the art, after reading this disclosure, how to make and use teleconferencing bridge 204.

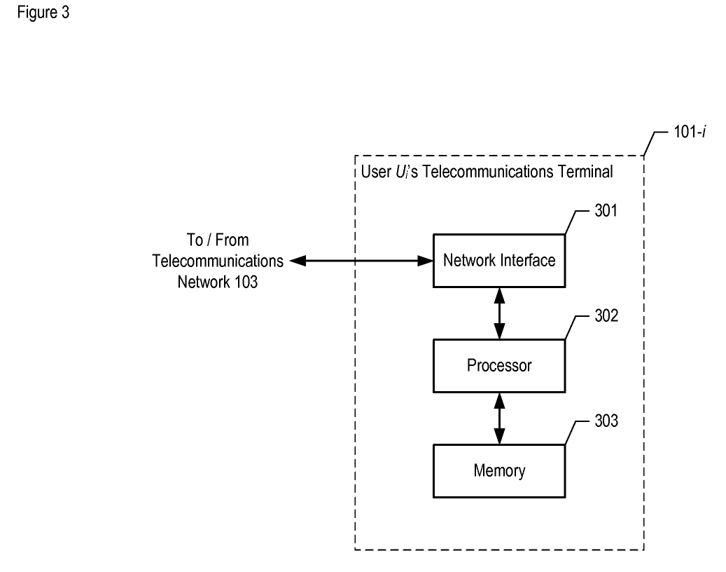

FIG. 3 depicts the salient components of a user Uᵢ's telecommunications terminal 101-i. Telecommunications terminal 101-i comprises network interface 301, processor 302, and memory 303 interconnected as shown. It will be clear to those skilled in the art, after reading this disclosure, how to make and use alternative embodiments of the present invention in which telecommunications terminal 101-i comprises any subcombination of the components listed above.

Network interface 301 comprises the circuitry that enables telecommunications terminal 101-i to receive signals from and, transmit signals to, other telecommunications terminals, a database, a gateway, server 102, other servers such as a proxy server, a Web server, etc.

Processor 302 is a general-purpose processor that is capable of receiving information from and transmitting information to network interface 301, executing the instructions stored in memory 303, including the instructions that correspond to the tasks of the illustrative embodiment, and reading data from and writing data into memory 303. In some alternative embodiments of the present invention, processor 302 is a special-purpose processor.

Memory 303 stores the instructions and data used by processor 302, in well-known fashion. Memory 303 also stores, for example, and without limitation, a profile associated with a user Uᵢ at telecommunications terminal 101-i. The profile comprises, for example, and without limitation:
i. the user Uᵢ's first name and last name,
ii. the user Uᵢ's geographic location,
iii. the academic institution that the user Uᵢ graduated from,
iv. the field of study that the user Uᵢ majored in while attending the academic
institution,
v. the enterprise (i.e., employer) that the user Uᵢ is currently working for,
vi. the department that the user Uᵢ is currently assigned to in the enterprise,
vii. a description of the user Uᵢ's daily task as a member of this department,
viii. the social groups that the user Uᵢ is a member of,
ix. the documents that the user Uᵢ has worked on or published in the past,
x. the user Uᵢ's expertise,
xi. the user Uᵢ's interests,
xii. the user Uᵢ's contact information,
xiii. a unique identifier of the user Uᵢ at telecommunications terminal 101-i,
xiv. the user Uᵢ's contacts—in other words, a unique identifier of other users in the user Uᵢ's social network (e.g., a unique identifier of a first user U₁ at telecommunications terminal 101-1, a second user U₂ at telecommunications terminal 101-2, a third user U₃ at telecommunications terminal 101-3, etc.),
xv. the number of times the telecommunications terminal 101-i transmitted a request to another telecommunications terminal,
xvi. a list of users that the telecommunications terminal 101-i transmitted a request to,
xvii. the number of times the user Uᵢ at telecommunications terminal 101-i established a communications session with another user,
xviii. the duration of time the user Uᵢ at telecommunications terminal 101-i communicated with another user,
xix. the date and time the user Uᵢ at telecommunications terminal 101-i communicated with another user,
xx. the number of times the user Uᵢ at telecommunications terminal 101-i was selected by the server 102 to respond to another user's request,
xxi. the subject matter of a conference call that the user Uᵢ at telecommunications terminal 101-i participated in,
xxii. the subject matter of a document submitted by the user Uᵢ at telecommunications terminal 101-i,
xxiii. the number of times the user Uᵢ at telecommunications terminal 101-i received a request from other telecommunications terminals,
xxiv. the number of times the user Uᵢ at telecommunications 101-i responded to another user's request, or
xxv. any combination of i, ii, iii, iv, v, vi, vii, viii, ix, x, xi, xii, xiii, xiv, xv, xvi, xvii, xviii, xix, xx, xxi, xxii, xxiii, and xxiv.

It will be clear to those skilled in the art, after reading this disclosure, how to make and use alternative embodiments of the present invention in which some of the user Uᵢ's information and data listed above are stored in one or more profiles associated with the user Uᵢ.

Additionally, it will be clear to those skilled in the art, after reading this disclosure, how to make and use alternative embodiments of the present invention in which memory 303 can be any combination of dynamic random-access memory (RAM), flash memory, disk drive memory, and so forth.

Furthermore, it will be clear to those skilled in the art, after reading this disclosure, how to make and use alternative embodiments of the present invention in which some or all of the above are stored in a different memory or database that is part of or, separate from, telecommunications terminal 101-i.

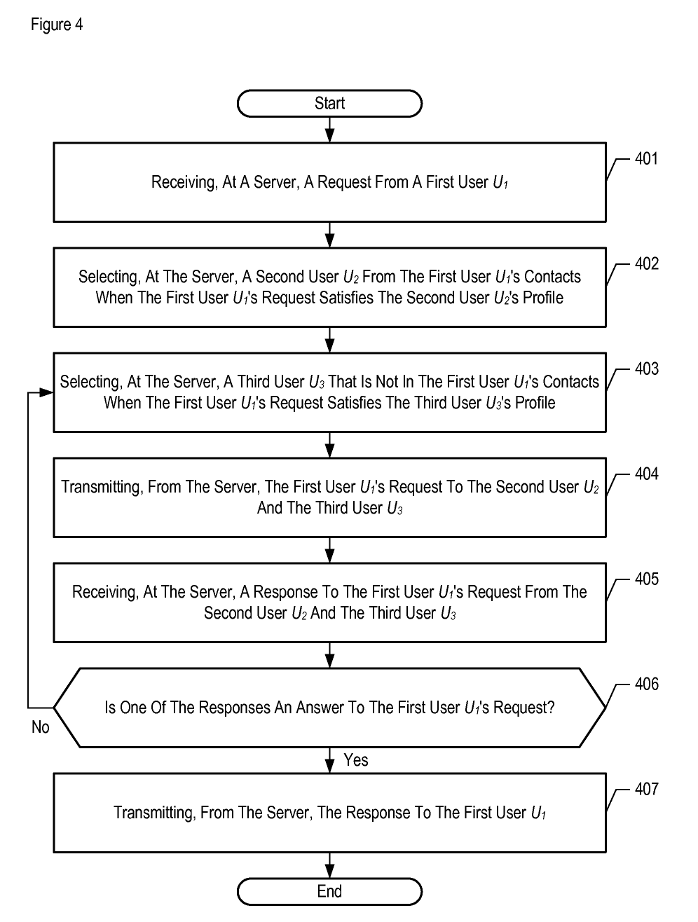

FIG. 4 depicts a flowchart of the salient tasks associated with the operation of the first illustrative embodiment of the present invention.

It will be clear to those skilled in the art, after reading this disclosure, how to make and use alternative embodiments of the present invention in which tasks 401, 402, 403, 404, 405, 406, and 407 are performed in a different order or are performed concurrently. Furthermore, it will be clear to those skilled in the art, after reading this disclosure, how to make and use alternative embodiments of the present invention that omit one or more tasks 401, 402, 403, 404, 405, 406, and 407.

The first illustrative embodiment of the present invention will be described in the context of a social community, but it will be clear to those skilled in the art, after reading this disclosure, how to make and use alternative embodiments of the present invention in which the method and system of the present invention can be implemented on other types of applications that permit a user to create their own social network (i.e., a user's list of contacts).

For clarity, the first illustrative embodiment of the present invention will be described with four users:

i. a first user U₁ at telecommunications terminal 101-1,

ii. a second user U₂ at telecommunications terminal 101-2,

iii. a third user U₃ at telecommunications terminal 101-3, and

iv. a fourth user U₄ at telecommunications terminal 101-4, but it will be clear to those skilled in the art, after reading this disclosure, how to make and use alternative embodiments of the present invention in which the social community can comprise any number of users, for example, and without limitation, one hundred users, one thousand users, one million users, etc.

In accordance with the first illustrative embodiment, the four users have registered or subscribed to the social community and have already created a profile, wherein each user Uᵢ's profile is stored in the server 102's memory 203. Each user Uᵢ's profile comprises the information and data previously described in FIG. 2.

In accordance with the first illustrative embodiment of the present invention, discovering and locating a person who possesses the expertise in a specific subject matter is performed by server 102.

In the first embodiment of the present invention, the first user Uᵢ accesses the social community via telecommunications terminal 101-1 and desires to obtain information on a specific subject matter, such as “string theory.” The first user U₁ can obtain this information from a person who possesses the knowledge or expertise in the subject matter “string theory” by inputting the following query via an interface:
“String Theory”

At the same time, the first user U₁ can also specify one or more criteria for transmitting a request (i.e., the first user U₁'s query) to server 102 and/or receiving a response to the request. The criteria can be, for example, and without limitation:
i. the number of times the first user U₁ established a communications session with another user,
ii. the duration of time the first user U₁ communicated with another user,
iii. the date and time the first user U₁ communicated with another user,
iv. the number of times a user was selected to respond to another user's query,
v. the subject matter of a conference call that another user participated in,
vi. the subject matter of a document submitted by another user,
vii. the number of times another user received a request from server 102 and/or other telecommunications terminals 101-i,
viii. the number of times a person responded to another user's request,
ix. the desired date and time for receiving a response to the first user U₁'s request,
x. the desired language of the response,
xi. the type of media in which the first user U₁ desires to receive the response (e.g., e-mail, instant message, SMS, video, voice, etc.),
xii. whether the first user U₁ desires to establish a communications session with the person responding to the first user U₁'s request, or
xiii. any combination of i, ii, iii, iv, v, vi, vii, viii, ix, x, xii, and xii.

It will be clear to those skilled in the art, after reading this disclosure, how to make and use alternative embodiments of the present invention in which the first user U₁ has the option of inputting the query without specify one or more criteria for transmitting the request to server 102 and/or receiving a response to the request.

Additionally, it will be clear to those skilled in the art, after reading this disclosure, how to make and use alternative embodiments of the present invention in which the first user U₁ can specify the one or more criteria via the same interface used to input the query or, via a different interface.

Once the first user U₁ has inputted the query and specified one or more criteria, the first user U₁'s telecommunications terminal 101-1 transmits a request to server 102. In particular, the first user U₁'s telecommunications terminal 101-1 transmits the query, the one or more criteria of the query, and the first user U₁'s unique identifier to server 102.

It will be clear to those skilled in the art, after reading this disclosure, how to make and use alternative embodiments of the present invention in which the first user U₁'s unique identifier is, for example, and without limitation, the first user U₁'s e-mail address, an employee identifier, the Media Access Control (MAC) address of the first user U₁'s telecommunications terminal 101-1, the Internet Protocol (IP) address of the first user U₁'s telecommunications terminal 101-1, etc.

Additionally, it will be clear to those skilled in the art, after reading this disclosure, how to make and use alternative embodiments of the present invention in which the query, the one or more criteria of the query, and the first user U₁'s unique identifier are transmitted from telecommunications terminal 101-1 concurrently (i.e., as one signal transmitted from telecommunications terminal 101-1) or simultaneously (i.e., two or more signals transmitted from telecommunications terminal 101-1) to server 102.

At task 401, server 102 receives the first user U₁'s request—that is, server 102 receives the first user U₁'s query, the one or more criteria, and the first user U₁'s unique identifier from telecommunications terminal 101-1.

At task 402, server 102 selects a user from the first user U₁'s contacts based, at least in part, on the first user U₁'s request. More particularly, server 102 selects a second user U₂ from the first user U₁'s contacts, wherein the first user U₁'s contacts comprises N users, and wherein N>=1. Once the second user U₂ is selected, server 102 determines whether the first user U₁'s one or more criteria satisfies the second user U₂'s profile.

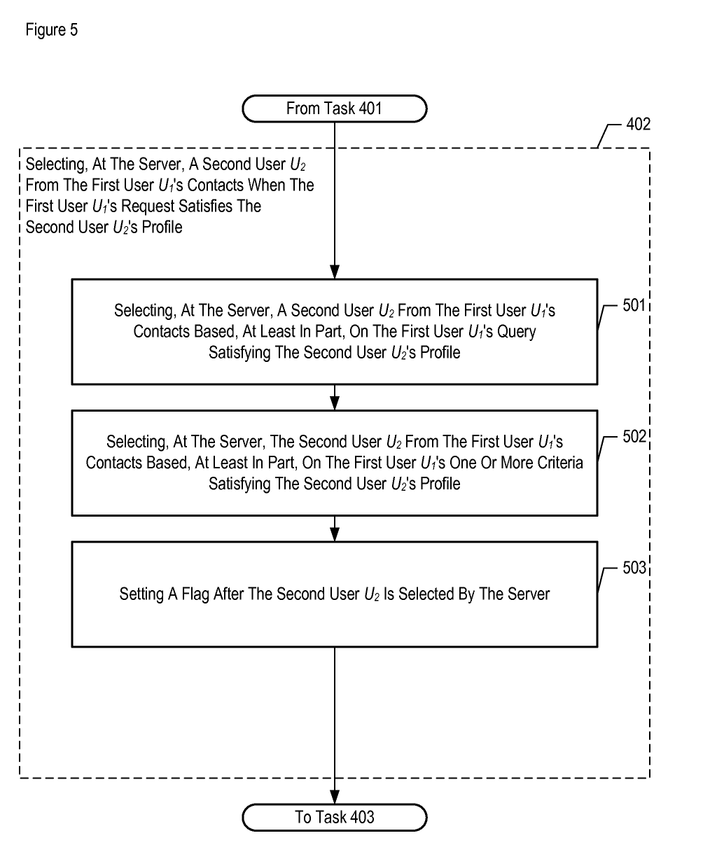

It will be clear to those skilled in the art, after reading this disclosure, how to make and use alternative embodiments of the present invention in which server 102 selects one or more users from the first user U₁'s contacts. Task 402 will be described in more detail below and with respect to FIG. 5.

At task 403, server 102 selects another user that is not in the first user U₁'s contacts based, at least in part, on the first user U₁'s request. More particularly, server 102 selects a third user U₃ from the second user U₂'s contacts, wherein the second user U₂'s contacts comprises M users, and wherein M>=1. Once the third user U₃ is selected, server 102 determines whether the first user U₁'s one or more criteria satisfies the third user U₃'s profile.

Selecting the third user U₃ from the second user U₂'s contacts is advantageous because once server 102 determines that the second user U₂ is knowledgeable in the subject matter “string theory,” the likelihood of a person in the second user U₂'s contacts also being knowledgeable in the subject matter “string theory” increases. Therefore, server 102 selects the third user U₃ from the second user U₂'s contacts, wherein the third user U₃ is not in the first user U₁'s contacts.

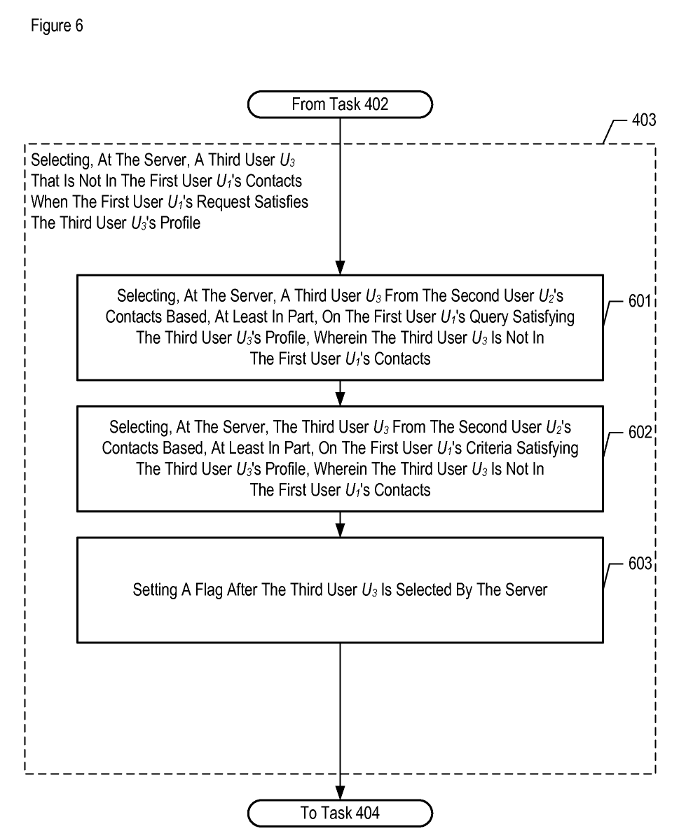

It will be clear to those skilled in the art, after reading this disclosure, how to make and use alternative embodiments of the present invention in which server 102 selects one or more users from the second user U₂'s contacts, wherein the one or more users are not in the first user U₁'s contacts. Task 403 will be described in more detail below and with respect to FIG. 6.

At task 404, server 102 transmits the first user U₁'s request to the second user U₂'s telecommunications terminal 101-2 and the third user U₃'s telecommunications terminal 101-3.

In accordance with the illustrative embodiment, server 102 transmits the first user U₁'s request to the second user U₂'s telecommunications terminal 101-2 and the third user U₃'s telecommunications terminal 101-3. Alternatively, server 102 does not transmit the first user U₁'s request to the second user U₂'s telecommunications terminal 101-2 and only transmits the first user U₁'s request to the third user U₃'s telecommunications terminal 101-3.

At task 405, server 102 receives a response to the first user U₁'s request from the second user U₂'s telecommunications terminal 101-2 and/or the third user U₃'s telecommunications terminal 101-3.

At task 406, server 102 determines whether the response from the second user U₂'s telecommunications terminal 101-2 and/or the third user U₃'s telecommunications terminal 101-3 is an answer to the first user U₁'s request. If the response is not an answer to the first user U₁'s request, the flow moves to task 403 and server 102 selects a different user to transmit the first user U₁'s request. On the other hand, if the response is an answer to the first user U₁'s request, the flow moves to task 407.

At task 407, server 102 transmits the response received from the second user U₂'s telecommunications terminal 101-2 and/or the third user U₃'s telecommunications terminal 101-3 to the first user U₁'s telecommunications terminal 101-1.

FIG. 5 depicts a flowchart of the salient task associated with the operation of task 402 in accordance with the first illustrative embodiment of the present invention.

It will be clear to those skilled in the art, after reading this disclosure, how to make and use alternative embodiments of the present invention in which tasks 501, 502, and 503 are performed in a different order or are performed concurrently. Furthermore, it will be clear to those skilled in the art, after reading this disclosure, how to make and use alternative embodiments of the present invention that omit one or more tasks 501, 502, and 503.

At task 501, server 102 selects a second user U₂ from the first user U₁'s contacts, wherein the first user U₁'s contacts comprises N users, and wherein N>=1. More particularly, since server 102 is configured to store the first user U₁'s profile, which comprises the first user U₁'s contacts, server 102 can determine that the first user U₁ is associated with N users by using the first user U₁'s unique identifier to search the server 102's memory 203 for the first user U₁'s profile.

Once server 102 determines that the first user U₁ is associated with N users, server 102 selects a second user U₂ from the first user U₁'s contacts based, at least in part, on whether the first user U₁'s request satisfies the second user U₂'s profile—that is, server 102 determines whether the first user U₁'s query “string theory” satisfies the information specified in one or more fields of the second user U₂'s profile.

For example, server 102 selects the second user U₂ from the first user U₁'s contacts. Once the second user U₂ is selected, server 102 uses the information specified in, for example, and without limitation, the “education” field of the second user U₂'s profile and compares it to the term “string theory.”

If the information specified in the “education” field satisfies the term “string theory,” the flow moves to task 502 in which server 102 determines whether the first user U₁'s one or more criteria satisfies the second user U₂'s profile.

On the other hand, if the information specified in the “education” field of the second user U₂'s profile does not satisfy the term “string theory,” server 102 uses the information specified in, for example, and without limitation, the “employer” field of the second user U₂'s profile and compares it to the term “string theory.”

If no information specified in the second user U₂'s profile satisfies the term “string theory,” server 102 selects another user from the first user U₁'s contacts and repeats the tasks described at task 501.

It will be clear to those skilled in the art, after reading this disclosure, how to make and use alternative embodiments of the present invention in which server 102 compares the term “string theory” in the first user U₁'s request with the information specified in one or more fields of the second user U₂'s profile.

At task 502, server 102 determines whether the first user U₁'s one or more criteria satisfies the second user U₂'s profile. The first user U₁'s one or more criteria is, for example, and without limitation, the number of times the first user U₁ established a communications session with another user in the past.

Since server 102 is configured to monitor the number of times the second user U₂ established a communications session with another user (e.g., the number of times the second user U₂ established a communications session with the first user U₁) and then include this information in the second user U₂'s profile, server 102 can determine whether the first user U₁'s one or more criteria satisfies the second user U₂'s profile. Once server 102 determines that the first user U₁'s request (i.e., the first user U₁'s query and the one or more criteria) satisfies the second user U₂'s profile, server 102 selects the second user U₂.

At task 503 and, after the second user U₂ has been selected, server 102 flags the second user U₂'s unique identifier to prevent the first user U₁'s request from being repeatedly transmitted to the second user U₂'s telecommunications terminal 101-2. More particularly, this flag is used by server 102 to identify that the second user U₂ was selected as an “expert” and that the first user U₁'s request was transmitted to the second user U₂'s telecommunications terminal 101-2—in other words, the flag is a mechanism used by server 102 to prevent looping of the first user U₁'s request. Once server 102 selects the second user U₂ and flags the second user U₂'s unique identifier, the flow moves to task 403.

FIG. 6 depicts a flowchart of the salient task associated with the operation of task 403 in accordance with the first illustrative embodiment of the present invention.

It will be clear to those skilled in the art, after reading this disclosure, how to make and use alternative embodiments of the present invention in which tasks 601, 602, and 603 are performed in a different order or are performed concurrently. Furthermore, it will be clear to those skilled in the art, after reading this disclosure, how to make and use alternative embodiments of the present invention that omit one or more tasks 601, 602, and 603.

At task 601, server 102 selects a third user U₃ that is not in the first user U₁'s contacts by selecting the third user U₃ from the second user U₂'s contacts, wherein the second user U₂'s contacts comprises M users, and wherein M>=1. More particularly, since server 102 is configured to store the second user U₂'s profile, which comprises the second user U₂'s contacts, server 102 can determine that the second user U₂ is associated with M users by using the second user U₂'s unique identifier to search the server 102's memory 203 for the second user U₂'s profile. Once server 102 determines that the second user U₂ is associated with M users, server 102 selects a third user U₃ from the second user U₂'s contacts based, at least in part, on whether the first user U₁'s request satisfies the third user U₃'s profile.

For example, server 102 selects the third user U₃ from the second user U₂'s contacts. Once the third user U₃ is selected, server 102 uses the information specified in, for example, and without limitation, the “interests” field of the third user U₃'s profile and compares it to the term “string theory” in the first user U₁'s query.

If the third user U₃'s interests satisfies the term “string theory,” the flow moves to task 602 in which server 102 determines whether the first user U₁'s one or more criteria satisfies the third user U₃'s profile.

On the other hand, if the third user U₃'s interests does not satisfy the term “string theory” in the first user U₁'s request, server 102 uses the information specified in, for example, and without limitation, the “expertise” field of the third user U₃'s profile and compares it to the term “string theory.”

If no information specified in the third user U₃'s profile satisfies the term “string theory,” server 102 selects another user from the second user U₂'s contacts and repeats the tasks described at task 601.

It will be clear to those skilled in the art, after reading this disclosure, how to make and use alternative embodiments of the present invention in which server 102 compares the term “string theory” in the first user U₁'s request with the information specified in one or more fields of the third user U₃'s profile.

At task 602, server 102 determines whether the first user U₁'s one or more criteria satisfies the third user U₃'s profile. The first user U₁'s one or more criteria is, for example, and without limitation, the number of times a user was selected by server 102 to respond to another user's query in the past.

Since server 102 is configured to monitor the number of times the third user U₃ was selected to respond to another user's query in the past, and then include this information in the third user U₃'s profile, server 102 can determine whether the first user U₁'s one or more criteria satisfies the third user U₃'s profile. Once server 102 determines that the first user U₁'s request (i.e., the first user U₁'s query and the one or more criteria) satisfies the third user U₃'s profile, server 102 selects the third user U₃.

At task 603 and, after the third user U₃ has been selected, server 102 flags the third user U₃'s unique identifier to prevent the first user U₁'s request from being repeatedly transmitted to the third user U₃'s telecommunications terminal 101-3. More particularly, this flag is used by server 102 to identify that the third user U₃ was selected as an “expert” and that the first user U₁'s request was transmitted to the third user U₃'s telecommunications terminal 101-3—in other words, the flag is a mechanism used by server 102 to prevent looping of the first user U₁'s request. Once server 102 selects the third user U₃ and flags the third user U₃'s unique identifier, the flow moves to task 404.

At task 404, server 102 transmits the first user U₁'s request to the second user U₂'s telecommunications terminal 101-2 and the third user U₃'s telecommunications terminal 101-3. Alternatively, server 102 does not transmit the first user U₁'s request to the second user U₂'s telecommunications terminal 101-2 and only transmits the first user U₁'s request to the third user U₃'s telecommunications terminal 101-3.

At task 405, server 102 receives a response to the first user U₁'s request from the second user U₂'s telecommunications terminal 101-2 and/or the third user U₃'s telecommunications terminal 101-3.

At task 406, server 102 determines whether the response from the second user U₂'s telecommunications terminal 101-2 and/or the third user U₃'s telecommunications terminal 101-3 is an answer to the first user U₁'s request. If the response is not an answer to the first user U₁'s request, the flow moves to task 403 and server 102 selects a different user to transmit the first user U₁'s request—that is, server 102 selects a fourth user U₄ from the third user U₃'s contacts, wherein the fourth user U₄ is not in the first user U₁'s contacts and the second user U₂'s contacts.

On the other hand, if the response is an answer to the first user U₁'s request, server 102 increments a counter associated with the second user U₂'s unique identifier and the third user U₃'s unique identifier, and the flow moves to task 407.

In accordance with the first illustrative embodiment, the counter is used by server 102 to calculate a value. This value is used by server 102 to determine an incentive or compensation that is applied to a user that responded to a request. For example, and without limitation, each time the second user U₂ and the third user U₃ answers one or more requests (i.e., one or more queries), server 102 increments a counter associated with a unique identifier of the second user U₂ and the third user U₃. Based at least in part on a predetermined time, T (e.g., one week, one month, one year, etc.), server 102 uses the counter to calculate a value, X, that is used to, for example, and without limitation, determine a monetary bonus at the end of the month or, determine a discount on a desired product.

At task 407, server 102 transmits the response received from the second user U₂'s telecommunications terminal 101-2 and/or the third user U₃'s telecommunications terminal 101-3 to the first user U₁'s telecommunications terminal 101-1.

In accordance with the first illustrative embodiment, server 102 transmits the second user U₂'s response and the third user U₃'s response to the first user U₁'s telecommunications terminal 101-1 because both the second user U₂ and the third user U₃ responded to the first user U₁'s request.

On the other hand, if one of the selected users (e.g., the second user U₂ or the third user U₃) did not respond to the first user U₁'s request, server 102 forwards the response to the user that did not respond to the first user U₁'s request based, at least in part, on the flag that was established at task 503 or task 603.

For example, and without limitation, if:

i. the second user U₂ did not respond to the first user U₁'s request, and

ii. the third user U₃ responded to the first user U₁'s request, server 102 transmits the third user U₃'s response to the first user U₁'s telecommunications terminal 101-1 and, forwards the third user U₃'s response to the second user U₂'s telecommunications terminal 101-2, wherein server 102 forwards the third user U₃'s response to the second user U₂'s telecommunications terminal 101-2 based, at least in part, on the flag that was established at task 503.

This is advantageous because the users that did not respond to the first user U₁'s request (i.e., the first user U₁'s query) may become interested in the topic of the request. To satisfy their interest or curiosity, server 102 forwards the response to these users.

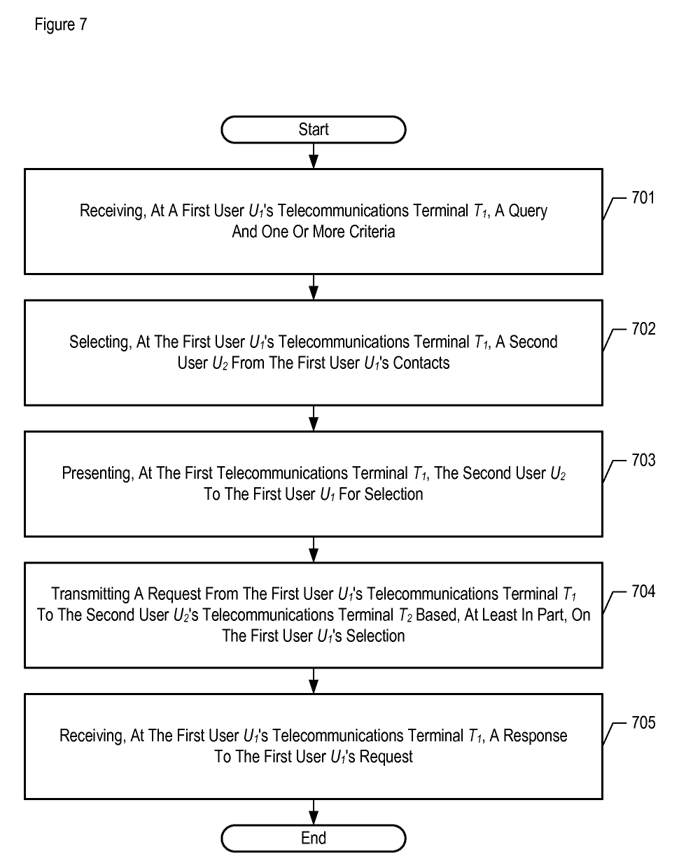

FIG. 7 depicts a flowchart of the salient tasks associated with the operation of the second illustrative embodiment of the present invention.

It will be clear to those skilled in the art, after reading this disclosure, how to make and use alternative embodiments of the present invention in which tasks 701, 702, 703, 704, and 705 are performed in a different order or are performed concurrently. Furthermore, it will be clear to those skilled in the art, after reading this disclosure, how to make and use alternative embodiments of the present invention that omit one or more tasks 701, 702, 703, 704, and 705.

In accordance with the second embodiment of the present invention, discovering and locating a person who possesses the expertise in a specific subject matter is performed by an application executed on a user Uᵢ's telecommunications terminal 101-i.

This application executed on a user Uᵢ's telecommunications terminal 101-i is a “plug-in” application or an “add-on” application that operates in conjunction with a host application (e.g., a Web browser or a Web page) executed on the user Uᵢ's telecommunications terminal 101-i. Alternatively, the application executed on a user Uᵢ's telecommunications terminal 101-i is an application that operates independently of the host application.

At task 701, the first user U₁ desires to obtain information on a specific subject matter, such as “string theory.” The first user U₁ invokes an application stored in memory 303 of telecommunications terminal 101-1 and inputs the following query via an interface:
“String Theory”

As part of task 701, the first user U₁ can also specify one or more criteria for transmitting a request (i.e., the first user U₁'s query) and/or receiving a response to the request. In accordance with the second illustrative embodiment, the first user U₁'s specifies that he desires to receive a response from an “expert” based on the number of times this “expert” responded to other queries. The first user U₁ specifies via an interface that the number is, for example, and without limitation:
“Greater than or Equal to Twenty (20)”

Alternatively, the one or more criteria can be, for example, and without limitation:
i. the number of times the first user U₁ established a communications session with a person,
ii. the duration of time the first user U₁ communicated with a person,
iii. the date and time the first user U₁ communicated with a person,
iv. the number of times a person was selected to respond to another person's query,
v. the subject matter of a conference call that a person participated in,
vi. the subject matter of a document submitted by a person,
vii. the number of times a person received a request from server 102 and/or other telecommunications terminals 101-i,
viii. the number of times a person responded to another person's request, or
ix. the desired date and time for receiving a response to the first user U₁'s request,
x. the desired language of the response,
xi. the type of media in which the first user U₁ desires to receive the response (e.g., e-mail, instant message, SMS, video, voice, etc.),
xii. whether the first user U₁ desires to establish a communications session with the person responding to the first user U₁'s request, or
xiii. any combination of i, ii, iii, iv, v, vi, vii, viii, ix, x, xii, and xii.

It will be clear to those skilled in the art, after reading this disclosure, how to make and use alternative embodiments of the present invention in which the first user U₁ has the option of inputting the query without specify one or more criteria for transmitting the request and/or receiving a response to the request.

Additionally, it will be clear to those skilled in the art, after reading this disclosure, how to make and use alternative embodiments of the present invention in which the first user U₁ provides the one or more criteria via the same interface used to input the query or, via a different interface.

At task 702, the application executed on the first user U₁'s telecommunications terminal 101-1 selects one or more users from the first user U₁'s contacts. Since the first user U₁'s telecommunications terminal 101-1 is configured to store the first user U₁'s profile, which comprises the first user U₁'s contacts, the application selects a second user U₂ from the first user U₁'s contacts.

It will be clear to those skilled in the art, after reading this disclosure, how to make and use alternative embodiments of the present invention in which the application executed on the first user U₁'s telecommunications terminal 101-1 selects more than one user from the first user U₁'s contacts.

At task 703, the application executed on the first user U₁'s telecommunications terminal 101-1 presents the second user U₂ to the first user U₁ for selection. As part of task 703, the first user U₁ has the option to include other users from the first user U₁'s contacts or exclude the second user U₂ for transmitting the first user U₁'s request.

It will be clear to those skilled in the art, after reading this disclosure, how to make and use alternative embodiments of the present invention wherein if more than one user is selected by the application executed on the first user U₁'s telecommunications terminal 101-1, a list that comprises the unique identifier of the selected users is presented to the first user U₁ for selection.

Additionally, it will be clear to those skilled in the art, after reading this disclosure, how to make and use alternative embodiments of the present invention wherein the first user U₁ has the option to include other users from the first user U₁'s contacts or, exclude one or more users for transmitting the first user U₁'s request.

At task 704, the application executed on the first user U₁'s telecommunications terminal 101-1 transmits the first user U₁'s request to the second user U₂'s telecommunications terminal 101-2 based, at least in part, on the first user U₁'s selection. More particularly, the application transmits the first user U₁'s query, the one or more criteria of the query, and the first user U₁'s unique identifier to the second user U₂'s telecommunications terminal 101-2.

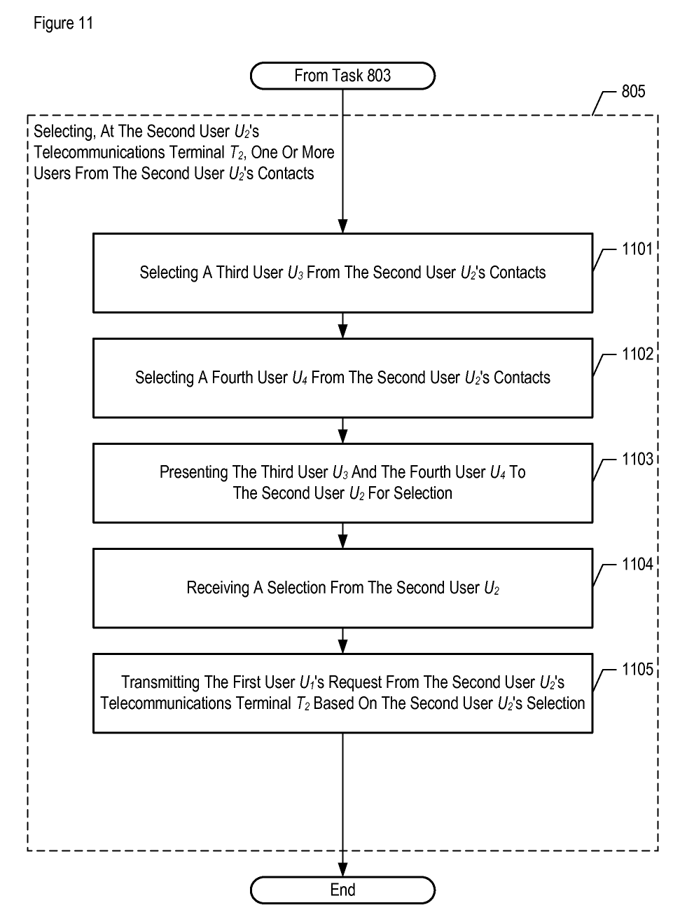

As part of task 704, if the first user U₁ selects more than one user for transmitting the request, the first user U₁'s telecommunications terminal 101-1 will transmit the unique identifier of these users to the second user U₂'s telecommunications terminal 101-2. The unique identifier of these users will be used by an application executed on the second user U₂'s telecommunications terminal to select one or more users from the second user U₂'s contacts, which will be described in more detail below and with respect to FIG. 11.

It will be clear to those skilled in the art, after reading this disclosure, how to make and use alternative embodiments of the present invention in which the first user U₁'s unique identifier can be, for example, and without limitation, the first user U₁'s e-mail address, an employee identifier, the Media Access Control (MAC) address of the first user U₁'s telecommunications terminal 101-1, the Internet Protocol (IP) address of the first user U₁'s telecommunications terminal 101-1, etc.

Additionally, it will be clear to those skilled in the art, after reading this disclosure, how to make and use alternative embodiments of the present invention in which the first user U₁'s query, the one or more criteria of the query, and the first user U₁'s unique identifier are transmitted from the first user U₁'s telecommunications terminal 101-1 concurrently (i.e., as one signal transmitted from the first user U₁'s telecommunications terminal 101-1) or simultaneously (i.e., two or more signals transmitted from the first user U₁'s telecommunications terminal 101-1) to the second user U₂'s telecommunications terminal 101-2.

At task 705, the application executed on the first user U₁'s telecommunications terminal 101-1 receives a response to the first user U₁'s request. Upon receiving the response, the application presents the response to the first user U₁.

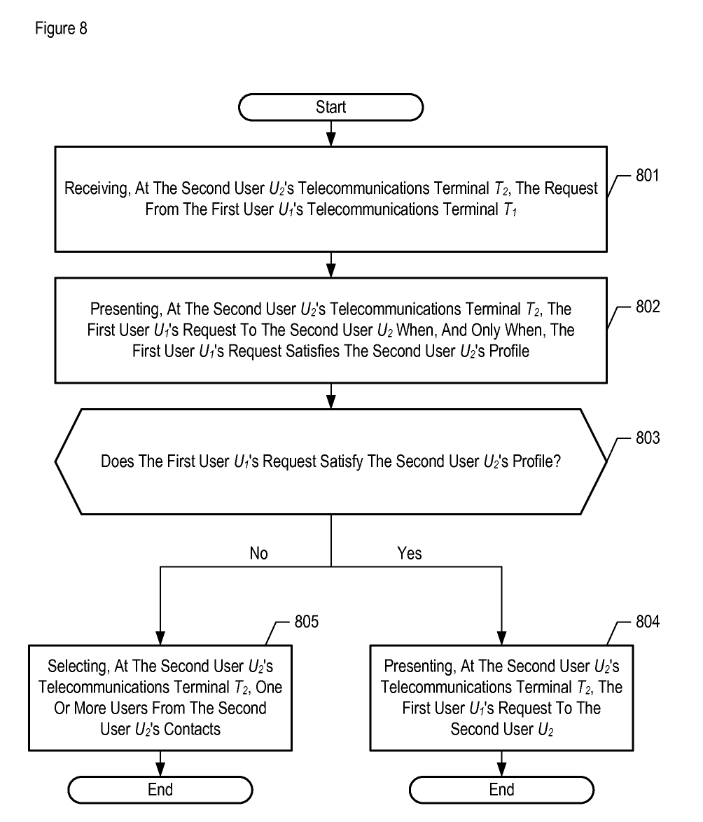

FIG. 8 depicts a flowchart of the salient tasks associated with the operation of the second illustrative embodiment of the present invention.

It will be clear to those skilled in the art, after reading this disclosure, how to make and use alternative embodiments of the present invention in which tasks 801, 802, 803, 804, and 805 are performed in a different order or are performed concurrently. Furthermore, it will be clear to those skilled in the art, after reading this disclosure, how to make and use alternative embodiments of the present invention that omit one or more tasks 801, 802, 803, 804, and 805.

At task 801, the second user U₂'s telecommunications terminal 101-2 receives the first user U₁'s request from the first user U₁'s telecommunications terminal 101-1—that is, the second user U₂'s telecommunications terminal 101-2 receives the first user U₁'s query, the one or more criteria of the query, and the first user U₁'s unique identifier.

At task 802, an application executed on the second user U₂'s telecommunications terminal 101-2 presents the first user U₁'s request to the second user U₂ when, and only when, the first user U₁'s request satisfies the second user U₂'s profile.

At task 803, the application executed on the second user U₂'s telecommunications terminal 101-2 determines whether the first user U₁'s request satisfies the second user U₂'s profile. In accordance with the second illustrative embodiment, if the applications determines that the first user U₁'s request satisfies the second user U₂'s profile, the flow moves to task 804 in which the application presents the first user U₁'s request (i.e., the first user U₁'s query) to the second user U₂.

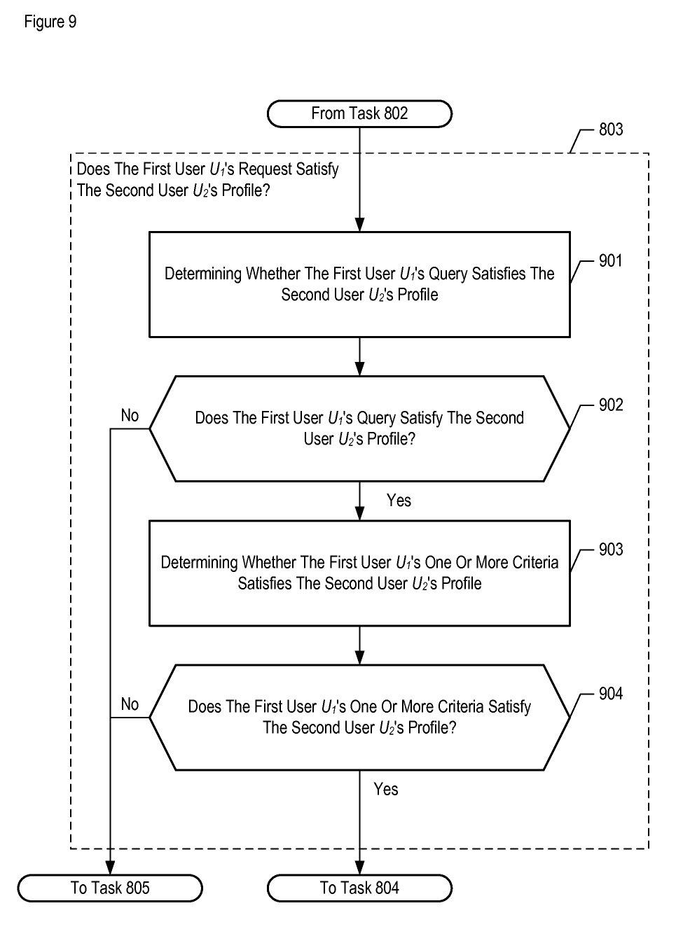

On the other hand, if the applications determines that the first user U₁'s request does not satisfy the second user U₂'s profile, the flow moves to task 805 in which the application selects one or more users from the second user U₂'s contacts, wherein the one or more users are not in the first user U₁'s contacts. Task 803 will be described in more detail below and with respect to FIG. 9.

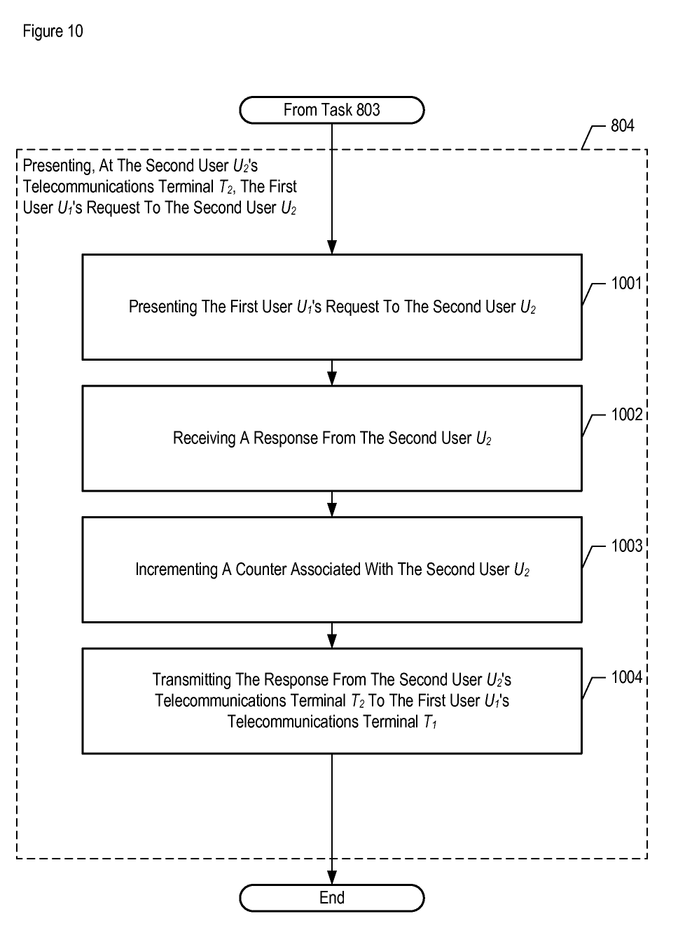

At task 804, the application executed on the second user U₂'s telecommunications terminal 101-2 presents the first user U₁'s request to the second user U₂ based on the fact that the first user U₁'s request satisfies the second user U₂'s profile. Task 804 will be described in more detail below and with respect to FIG. 10.

At task 805, when the application executed on the second user U₂'s telecommunications terminal 101-2 determines that the first user U₁'s request does not satisfy the second user U₂'s profile, the application selects one or more users from the second user U₂'s contacts, wherein the one or more users are not in the first user U₁'s contacts. Task 805 will be described in more detail below and with respect to FIG. 11.

FIG. 9 depicts a flowchart of the salient task associated with the operation of task 803 in accordance with the second illustrative embodiment of the present invention.

It will be clear to those skilled in the art, after reading this disclosure, how to make and use alternative embodiments of the present invention in which tasks 901, 902, 903, and 904 are performed in a different order or are performed concurrently. Furthermore, it will be clear to those skilled in the art, after reading this disclosure, how to make and use alternative embodiments of the present invention that omit one or more tasks 901, 902, 903, and 904.

At task 901, the application executed on the second user U₂'s telecommunications terminal 101-2 determines whether the first user U₁'s request satisfies the second user U₂'s profile. Since the second user U₂'s telecommunications terminal 101-2 is configured to store the second user U₂'s profile, the application executed on the second user U₂'s telecommunications terminal 101-2 can determine whether the term “string theory” satisfies the information specified in one or more fields of the second user U₂'s profile. For example, and without limitation, the application uses the information specified in, the “education” field of the second user U₂'s profile and compares it to the term “string theory.”

At task 902, if the information specified in the “education” field satisfies the term “string theory,” the flow moves to task 903 wherein the application executed on the second user U₂'s telecommunications terminal 101-2 determines whether the first user U₁'s one or more criteria satisfies the second user U₂'s profile.

On the other hand, if the information specified in the “education” field of the second user U₂'s profile does not satisfy the term “string theory,” the application executed on the second user U₂'s telecommunications terminal 101-2 uses the information specified in, for example, and without limitation, the “employer” field of the second user U₂'s profile and compares it to the term “string theory.”

If no information specified in the second user U₂'s profile satisfies the term “string theory,” the flow moves to task 805 in which the application executed on the second user U₂'s telecommunications terminal 101-2 selects one or more users from the second user U₂'s contacts, wherein the one or more users are not in the first user U₁'s contacts.

It will be clear to those skilled in the art, after reading this disclosure, how to make and use alternative embodiments of the present invention in which the application executed on the second user U₂'s telecommunications terminal 101-2 compares the term “string theory” in the first user U₁'s request with the information specified in one or more fields of the second user U₂'s profile.

At task 903, the application executed on the second user U₂'s telecommunications terminal 101-2 determines whether the first user U₁'s one or more criteria satisfies the second user U₂'s profile. The first user U₁'s one or more criteria is, for example, and without limitation, the number of times a person responded to other queries.

Since the second user U₂'s telecommunications terminal 101-2 is configured to monitor the number of times the second user U₂ was selected to respond to another user's query in the past, and then include this information in the second user U₂'s profile, the application executed on the second user U₂'s telecommunications terminal 101-2 can determine whether first user U₁'s one or more criteria satisfies the second user U₂'s profile.

At task 904, if the first user U₁'s one or more criteria satisfies the information specified in the second user U₂'s profile, the flow moves to task 804 wherein the application executed on the second user U₂'s telecommunications terminal 101-2 presents the first user U₁'s request (i.e., the first user U₁'s) to the second user U₂.

On the other hand, if the first user U₁'s one or more criteria does not satisfy any information specified in the second user U₂'s profile, the flow moves to task 805 wherein the application selects one or more users from the second user U₂'s contacts. Task 805 will be described in more detail below and with respect to FIG. 11.

FIG. 10 depicts a flowchart of the salient task associated with the operation of task 804 in accordance with the second illustrative embodiment of the present invention.

It will be clear to those skilled in the art, after reading this disclosure, how to make and use alternative embodiments of the present invention in which tasks 1001, 1002, 1003, and 1004 are performed in a different order or are performed concurrently. Furthermore, it will be clear to those skilled in the art, after reading this disclosure, how to make and use alternative embodiments of the present invention that omit one or more tasks 1001, 1002, 1003, and 1004.

At task 1001, the application executed on the second user U₂'s telecommunications terminal 101-2 presents the first user U₁'s request (i.e., the first user U₁'s query) to the second user U₂ based on the fact that the first user U₁'s request satisfies the second user U₂'s profile.

At task 1002, the application executed on the second user U₂'s telecommunications terminal 101-2 receives a response (i.e., an answer) to the first user U₁'s request from the second user U₂.

At task 1003, the application executed on the second user U₂'s telecommunications terminal 101-2 increments a counter associated with the second user U₂'s unique identifier, which is used by the application to calculate a value for determining an incentive or compensation that is applied to the second user U₂. For example, and without limitation, each time the second user U₂ answers one or more requests (i.e., one or more queries), the application executed on the second user U₂'s telecommunications terminal 101-2 increments a counter associated with a unique identifier of the second user U₂. Based at least in part on a predetermined time, T (e.g., one week, one month, one year, etc.), the application uses the counter to calculate a value, X, that is used to, for example, and without limitation, determine a monetary bonus at the end of the month or, determine a discount on a desired product.

At task 1004, the application executed on the second user U₂'s telecommunications terminal 101-2 transmits the second user U₂'s response to the first user U₁'s telecommunications terminal 101-1.

Referring again to task 705 of FIG. 7, the first user U₁'s telecommunications terminal 101-1 receives the second user U₂'s response from the second user U₂'s telecommunications terminal 101-2 and presents the response to the first user U₁.

FIG. 11 depicts a flowchart of the salient task associated with the operation of task 805 in accordance with the second illustrative embodiment of the present invention.

It will be clear to those skilled in the art, after reading this disclosure, how to make and use alternative embodiments of the present invention in which tasks 1101, 1102, 1103, 1104, and 1105 are performed in a different order or are performed concurrently. Furthermore, it will be clear to those skilled in the art, after reading this disclosure, how to make and use alternative embodiments of the present invention that omit one or more tasks 1101, 1102, 1103, 1104, and 1105.

At task 1101, when the application executed on the second user U₂'s telecommunications terminal 101-2 determines that the first user U₁'s request does not satisfy the second user U₂'s profile, the application selects a third user U₃ from the second user U₂'s contacts, wherein the third user U₃ is not in the first user U₁'s contacts. This selection performed by the application is based, at least in part, on the first user U₁'s request and the unique identifiers transmitted from the first user U₁'s telecommunications terminal 101-1 at task 704.

More particularly, to prevent looping of the first user U₁'s request (i.e., transmitting the first user U₁'s request to the same user Uᵢ's telecommunications terminal 101-i), the application executed on the second user U₂'s telecommunications terminal 101-2 compares the identifiers transmitted from the first user U₁'s telecommunications terminal 101-1 at task 704 with the second user U₂'s contacts to determine whether any users in the second user U₂'s contacts have already received the first user U₁'s request.

At task 1102 and, in the same or similar fashion as described at task 1101, the application executed on the second user U₂'s telecommunications terminal 101-2 selects a fourth user U₄ from the second user U₂'s contacts based, at least in part, on the first user U₁'s request and the unique identifiers transmitted from the first user U₁'s telecommunications terminal 101-1 at task 704, wherein the fourth user U₄ is not in the first user U₁'s contacts.

At task 1103, the application executed on the second user U₂'s telecommunications terminal 101-2 presents the third user U₃ and the fourth user U₄ to the second user U₂ for selection—in other words, a list that comprises a unique identifier associated with the third user U₃ and the fourth user U₄ is presented to the second user U₂ for selection. It will be clear to those skilled in the art, after reading this disclosure, how to make and use alternative embodiments of the present invention in which the unique identifier of the third user U₃ and the fourth user U₄ comprises, for example, and without limitation, their full name, e-mail address, employee identifier, etc.

As part of task 1103, the second user U₂ has the option of including other users from the second user U₂'s contacts (i.e., a fifth user U₅, a sixth user U₆, a seventh user U₇, etc.) and, to exclude the third user U₃ and/or the fourth user U₄ for transmitting the first user U₁'s request.

At task 1104, the application executed on the second user U₂'s telecommunications terminal 101-2 receives a selection from the second user U₂. In accordance with the second illustrative embodiment, the second user U₂ selects the third user U₃ and the fourth user U₄ for transmitting the first user U₁'s request.

At task 1105, the second user U₂'s telecommunications terminal 101-2 transmits the first user U₁'s request to the third user U₃'s telecommunications terminal 101-3 and the fourth user U₄'s telecommunications terminal 101-4. More particularly, the second user U₂'s telecommunications terminal 101-2 transmits:
i. the first user U₁'s query,
ii. the one or more criteria of the query,
iii. the unique identifiers transmitted from the first telecommunications terminal 101-1, and
iv. the unique identifier of the second user U₂, to the third user U₃'s telecommunications terminal 101-3 and the fourth user U₄'s telecommunications terminal 101-4.

Once the second user U₂'s telecommunications terminal 101-2 transmits the first user U₁'s request to the third user U₃'s telecommunications terminal 101-3 and the fourth user U₄'s telecommunications terminal 101-4, an application executed on the third user U₃'s telecommunications terminal 101-3 and the fourth user U₄'s telecommunications terminal 101-4 performs the tasks previously described in FIGS. 8 through 11 upon receiving the first user U₁'s request from the second user U₂'s telecommunications terminal 101-2.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving, at a data-processing system, a request from a first user U₁;
selecting, at the data-processing system:
i. a second user U₂ from a plurality of contacts of the first user U₁, wherein the request satisfies the second user U₂'s profile, and
ii. a third user U₃ from a plurality of contacts of the second user U₂, wherein the request satisfies the third user U₃'s profile, and wherein the third user U₃ is not in the plurality of contacts of the first user U₁;
transmitting the request from the data-processing system to the third user U₃;
receiving, at the data-processing system, a response to the request from the third user U₃; and
transmitting, at the data-processing system, the response to the first user U₁.

2. The method of claim 1 wherein selecting the second user U₂ is based on the number of times the first user U₁ communicated with the second user U₂ before the data-processing system received the request from the first user U₁.

3. The method of claim 1 wherein selecting the second user U₂ is based on the duration of time the first user U₁ communicated with the second user U₂ before the data-processing system received the request from the first user U₁.

4. The method of claim 1 wherein selecting the second user U₂ is based on the date and time the first user U₁ communicated with the second user U₂ before the data-processing system received the request from the first user U₁.

5. The method of claim 1 wherein selecting the second user U₂ is based on the number of times the data-processing system selected the second user U₂ to respond to other requests.

6. The method of claim 1 wherein selecting the second user U₂ is based on the second user U₂ participating in a conference call with the same subject matter as the first user U₁'s request.

7. The method of claim 1 further comprising setting a flag after the data-processing system selects the second user U₂, wherein the data-processing system transmits the third user U₃'s response to the second user U₂ based, at least in part, on the flag.

8. The method of claim 1 further comprising incrementing a counter associated with an identifier of the third user U₃, wherein the counter is incremented based, at least in part, on receiving the response from the third user U₃.

9. A method comprising:
receiving, at a first terminal T₁, a query from a first user U₁;
transmitting a request from the first terminal T₁ to a second user U₂ at a second terminal T₂, wherein the second user U₂ is in the first user U₁'s contacts;
presenting the first user U₁'s request to the second user U₂ when, and only when, an application executed on the second terminal T₂ determines that the first user U₁'s request satisfies the second user U₂'s profile, wherein if the first user U₁'s request fails to satisfy the second user U₂'s profile, the application:
i. selects a third user U₃ from the second user U₂'s contacts,
ii. selects a fourth user U₄ from the second user U₂'s contacts, and
iii. presents the third user U₃ and the fourth user U₄ to the second user U₂ for selection;
receiving, at the second terminal T₂, a selection from the second user U₂; and
transmitting, at the second terminal T₂, the first user U₁'s request based on the second user U₂'s selection.

11. The method of claim 9 wherein the third user U₃ and the fourth user U₄ are not in the first user U₁'s contacts.

12. The method of claim 9 wherein transmitting the first user U₁'s request from the first terminal T₁ to the second terminal T₂ is based on the number of times the first user U₁ communicated with the second user U₂.

13. The method of claim 9 wherein transmitting the first user U₁'s request to the second terminal T₂ is based on the duration of time the first user U₁ communicated with the second user U₂.

14. The method of claim 9 wherein transmitting the first user U₁'s request to the second terminal T₂ is based on the date and time the first user U₁ communicated with the second user U₂.

15. The method of claim 9 wherein transmitting the first user U₁'s request to the second terminal T₂ is based on the number of times the second user U₂ was selected to respond to other requests.

16. The method of claim 9 wherein transmitting the first user U₁'s request to the second terminal T₂ is based on the second user U₂ participating in a conference call that has the same subject matter as the first user U₁'s request.

17. The method of claim 9 further comprising incrementing a counter associated with an identifier of the second user U₂, wherein the counter is incremented based, at least in part, on the second user U₂ responding to the first user U₁'s request.
